(19) United States
(12) Patent Application Publication
(10) Pub. No.: US 2016/0072103 A1
(43) Pub. Date: Mar. 10, 2016

(54) BATTERY DISPOSED WITHIN GAS FILLED CASE

(71) Applicant: Kevin Renn, Fort Myers, FL (US)

(72) Inventor: Kevin Renn, Fort Myers, FL (US)

(21) Appl. No.: 14/846,256

(22) Filed: Sep. 4, 2015

Related U.S. Application Data
(60) Provisional application No. 62/046,630, filed on Sep. 5, 2014.

(51) Int. Cl. H01M 2/02

(52) U.S. Cl. CPC H01M 2/0202; H01M 2/024; H01M 2200/00

(57) ABSTRACT

A battery encased in a noble gas is provided. An outer casing forming an airtight housing contains the battery. At least one noble gas is disposed within the airtight housing in between the battery and the outer casing. The noble gas prevents the battery from lighting on fire when an electrical discharge occurs.

### CROSS-REFERENCE TO RELATED APPLICATION

This application claims the benefit of priority of U.S. provisional application No. 62/046,630, filed Sep. 5, 2014, the contents of which are herein incorporated by reference.

### BACKGROUND OF THE INVENTION

The present invention relates to batteries and, more particularly, to an encasing for batteries.

An electric battery is a device consisting of one or more electrochemical cells that convert stored chemical energy into electrical energy. Each cell contains a positive terminal, or cathode, and a negative terminal, or anode. Electrolytes allow ions to move between the electrodes and terminals, which allows current to flow out of the battery to perform work. Currently, batteries are encased in plastic. Some batteries may be flammable and can be dangerous.

As can be seen, there is a need for a method of preventing batteries from catching on fire.

### SUMMARY OF THE INVENTION

In one aspect of the present invention, an apparatus comprises: an outer casing comprising an airtight housing within; a battery disposed within the airtight housing; and at least one noble gas disposed within the airtight housing in between the battery and the outer casing.

In another aspect of the present invention, a method of encasing a battery comprises: providing an outer casing having an internal housing, wherein the outer casing comprises a lid covering an opening leading into the internal housing, wherein the lid forms an airtight seal within the internal housing when covering the opening; securing a battery within the housing and closing the lid, forming the airtight seal; injecting a noble gas into the housing through a gas inlet valve formed through the outer casing.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded view of an embodiment of the present invention;

FIG. 3 is a section view of an embodiment of the present invention, taken along line 3-3 in FIG. 1; and

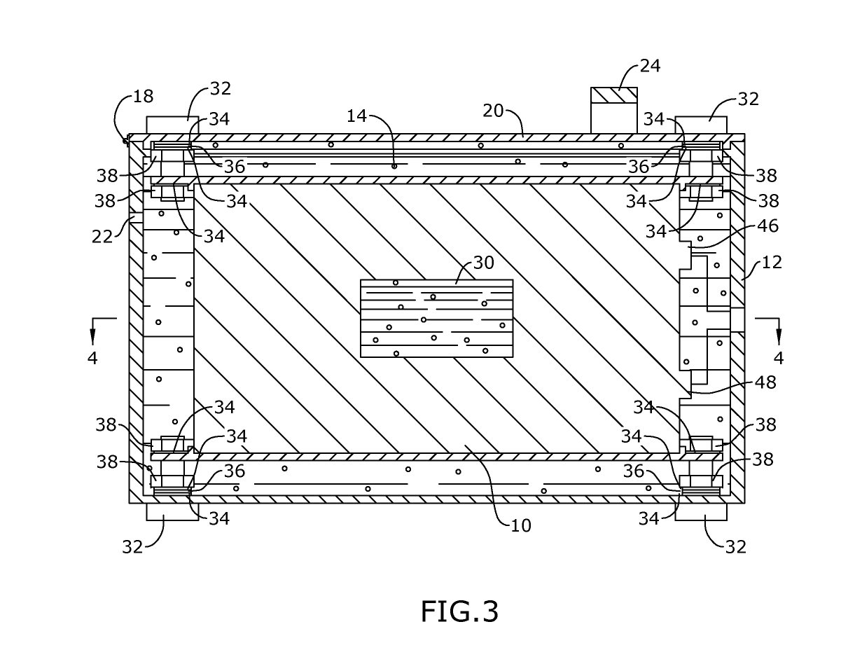

FIG. 4 is a section view of an embodiment of the present invention, taken along line 4-4 in FIG. 3.

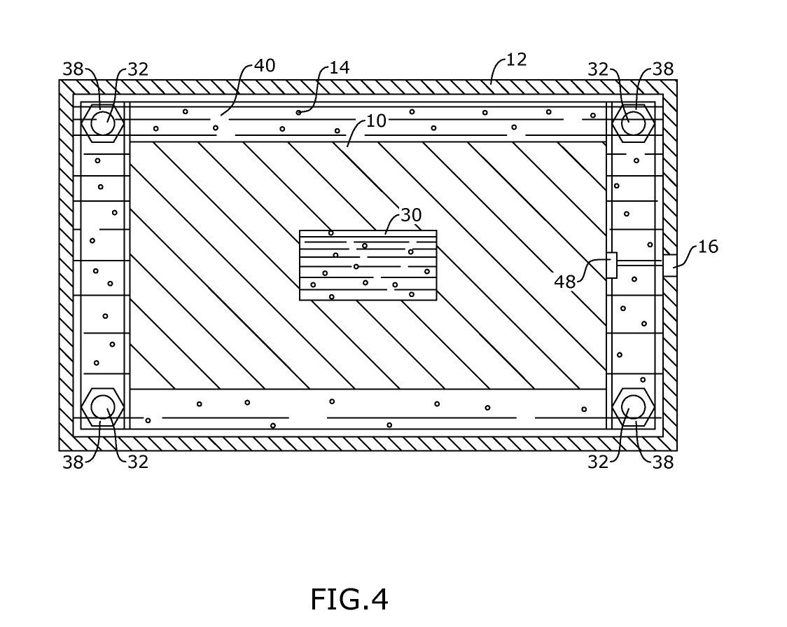

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a battery encasing having a housing, a battery within the housing, and a noble gas disposed within the housing and substantially surrounding the battery.

The present invention includes potentially flammable batteries that are encased in a plastic housing. A noble gas is disposed in between the plastic housing and the battery, thereby preventing highly flammable batteries, such as lithium batteries, from burning. The hard plastic may be filled with Argon gas or other noble gasses. By incasing the battery in a housing with argon gas, the battery is chemically and physically isolated from oxygen. Therefore, if an electrical discharge occurs the battery is unlikely to catch fire or explode.

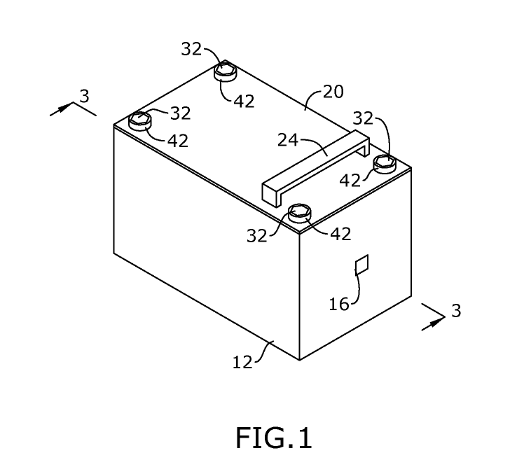

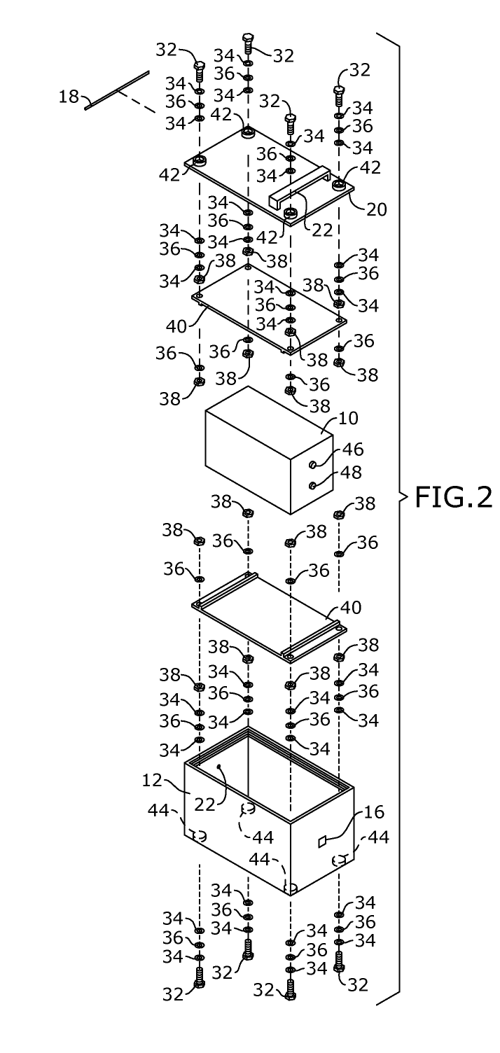

Referring to FIGS. 1 and 2, the present invention includes an outer casing 12 forming an airtight housing within. A battery 10 is disposed within the airtight housing of the outer casing 12. At least one noble gas 14 is disposed within the airtight housing in between the battery 10 and the outer casing 12. The noble gas 14 prevents the battery 10 from lighting on fire when an electrical discharge occurs.

In certain embodiments, the outer casing 12 may be about 10 mm thick and the battery 10 casing may be about 3 mm thick. A gap of about 6 mm may be formed in between the outer casing 12 and the battery 10.

The outer casing 12 of the present invention may be formed of a rigid material, such as a rigid plastic. An electrical interface 16 or plug may be formed through the outer casing 12 and electrically connect with the positive 46 and negative 48 battery leads of the battery 12. In certain embodiments, the outer casing 12 may include a lid 20. The lid 20 may be connected to the outer casing 12 by a hinge 18. The lid 20 covers an opening leading into the airtight housing. The lid 20 forms an airtight seal within the airtight housing when the lid 20 is covering the opening, i.e. when the lid 20 is closed shut. The lid 20 may include a handle 24. Therefore, the lid 20 may easily open and close so that a user may access the housing for battery 10 repairs and replacement.

The housing 12 of the present invention may be filled with at least one noble gas 14, such as a plurality of noble gases 14. The noble gasses 14 include helium (He), neon (Ne), argon (Ar), krypton (Kr), xenon (Xe), radon (Rn), and element 118 (temporarily named ununoctium [Uuo]). For example, the noble gas 14 may be Argon. The noble gas 14 may prevent the battery from catching on fire. In certain embodiments, the housing 12 may include an injection port or valve 22. Therefore, the user may insert the battery 10 into the housing 12, bolt the battery 10 to the internal sidewall of the housing 12, close the lid 20 and inject the housing with the noble gas 14. The battery 10 may be connected to a device to provide power to the device via the electrical interface 16.

The battery 10 of the present invention may include a flammable battery, such as a lithium battery. In certain embodiments, the batter 10 may further include a core 30. The core 30 may include an airtight compartment. A noble gas 14 may be disposed within the airtight compartment. The noble gas 14 disposed within the battery 10 may further reduce the flammability of the battery 10.

In alternate embodiments, the present invention may include an oxygen detector disposed in between the battery 10 and the outer casing 12. An alarm may be coupled to the oxygen detector. The alarm may include a sound generating alarm and/or a light generating alarm. When the oxygen detector detects oxygen in between the battery 10 and the outer casing 12, the alarm may go off, thereby notifying a user that the battery has a leak and is potentially dangerous.

To secure the battery 10 to the outer casing 12 within the housing, the present invention may include a top battery clamp plate 40 and a bottom battery clamp plate 40. The clamp plates 40 may include protruding ridges in which the battery 10 fits in between. The lid 20 of the present invention may include lid bolt posts 42 having apertures that align with apertures formed through the top clamp plate 40. Bolts 32 may run through a first rubber washer 34, a metal washer 36, a second rubber washer 34, through the aperture formed in the lid bolt posts 42, another first rubber washer 34, metal washer 36, and second rubber washer 34, and through the aperture formed in the top clamp plate 40. Another metal washer 36 and a nut 38 may be secured to the bolt beyond the top clamp plate 40 and tightened to form an airtight seal. A bottom side of the outer casing 12 may include bottom bolt posts 44 having apertures that align with apertures formed through the bottom clamp plate 40. Bolts 32 may run through a first rubber washer 34, a metal washer 36, a second rubber washer 34, through the aperture formed in the bottom bolt posts 44, another first rubber washer 34, metal washer 36, and second rubber washer 34, and through the aperture formed in the bottom clamp plate 40. Another metal washer 36 and a nut 38 may be secured to the bolt beyond the bottom clamp plate 40 and tightened to form an airtight seal. A bolt 32 may run through each corner of the lid 20 and the bottom side of the outer casing 12 to provide the airtight seal.

A method of encasing a battery may include the following. The lid of the outer casing may be opened. A battery is secured within the housing. The lid is then closed, forming an airtight seal within the housing. A noble gas is then injected into the housing through the gas inlet valve formed through the outer casing.

It should be understood, of course, that the foregoing relates to exemplary embodiments of the invention and that modifications may be made without departing from the spirit and scope of the invention as set forth in the following claims.

What is claimed is:

1. An apparatus comprising:
an outer casing comprising an airtight housing within;
a battery disposed within the airtight housing; and
at least one noble gas disposed within the airtight housing in between the battery and the outer casing.

2. The apparatus of claim 1, wherein the outer casing is formed of a rigid plastic.

3. The apparatus of claim 1, wherein the outer casing comprises a lid covering an opening leading into the airtight housing, wherein the lid forms an airtight seal when covering the opening.

4. The apparatus of claim 3, wherein a hinge connects the lid to the outer casing.

5. The apparatus of claim 1, wherein the outer casing further comprises a gas inlet valve.

6. The apparatus of claim 1, wherein the battery comprises a core comprising an air tight compartment, wherein a noble gas is disposed within the airtight compartment.

7. The apparatus of claim 1, wherein the noble gas is a plurality of noble gasses.

8. The apparatus of claim 1, wherein the noble gas is Argon.

9. A method of encasing a battery comprising:
providing an outer casing having an internal housing, wherein the outer casing comprises a lid covering an opening leading into the internal housing, wherein the lid forms an airtight seal within the internal housing when covering the opening;
securing a battery within the housing and closing the lid, forming the airtight seal;
injecting a noble gas into the housing through a gas inlet valve formed through the outer casing.

10. The method of claim 9, wherein the noble gas is Argon.
